(19) United States
(12) Patent Application Publication
(10) Pub. No.: US 2026/0307574 A1
(43) Pub. Date: Oct. 8, 2026

(54) TRAILER

(71) Applicant: DAYS LLC, Elkhart, IN (US)

(72) Inventors: Jason Loose, Cassopolis, MI (US); Garrett Green, Cassopolis, MI (US)

(21) Appl. No.: 19/173,288

(22) Filed: Apr. 8, 2025

Related U.S. Application Data
(60) Provisional application No. 63/575,966, filed on Apr. 8, 2024.

(51) Int. Cl. B60P 3/07; B60P 1/04; B60P 1/43

(52) U.S. Cl. CPC B60P 3/07; B60P 1/04; B60P 1/433

(57) ABSTRACT

A trailer for loading multiple small vehicles, such as UTVs, where the trailer is shorter than the combined length of the small vehicles. The trailer includes a frame, a pair of ramps, and a connector that pivots the pair of ramps. The pair of ramps are designed to have a lowered position that fits in a recessed portion of the frame and a raised position that provides storage space underneath the raised pair of ramps. This allows a portion of one vehicle to be stored beneath another vehicle. The trailer may be 20 feet long and capable of being towed by a 1/2 ton pickup truck.

### BACKGROUND OF THE DISCLOSURE

### 1. Field of the Disclosure

This disclosure relates to devices and methods for transporting vehicles.

### 2. Description of the Related Art

Utility task vehicles (UTVs) and side-by-sides are four or six-wheeled off road vehicles built for work and recreation. They are commonly used to transport equipment and supplies to locations where truck transportation is impractical or impossible.

In many instances, due to convenience or limited range, the UTVs themselves require transport on road. When it comes to transporting UTVs and side-by-sides, one of the biggest challenges is their weight and the space they occupy. Traditionally, to transport two of these hefty machines, a 24-foot or longer trailer is required. Such a trailer presents significant problem when using a standard ½ ton pickup truck. The sheer length and weight of a trailer loaded with over 7000 pounds of payload makes it incredibly difficult to tow. Transporting such a load resulting strain on the vehicle and dramatically reduces fuel efficiency. The owners of a 24-foot standard trailer often require a ¾ ton pickup truck for effective towing.

Additionally, navigating tight spaces with a long trailer can be a nightmare. The turning radius required for longer trailers makes maneuvering them in and out of confined areas extremely challenging.

Some trailers are designed to manage space issues by adding a loading ramp so the UTV may be driven onto the front of a smaller trailer. However, the addition of a loading ramp introduces additional problems. Driving up a steep loading ramp and then climbing out of the vehicle with its front end elevated is not only awkward but also dangerous. Getting back into the UTV can be even more hazardous.

Another significant issue with having the front end of the UTV elevated is the increased aerodynamic drag. Aerodynamic drag severely impacts fuel efficiency, making trips more costly.

What is needed is a trailer for transporting multiple UTVs that provides one or more of the benefits of: (1) being light enough to be hauled by a ½ ton pickup truck, (2) allowing UTVs to be loaded and unloaded on a flat surface, (3) lowering aerodynamic drag during transport to improve fuel efficiency, (4) being short enough for easier turns and more manageable backing up, (5) not requiring a ramp for loading of the UTVs on to the trailer from the ground, and reducing the chances of injuries and accidents during entrance and egress from the loaded UTVs.

### BRIEF SUMMARY OF THE DISCLOSURE

The trailer and method of use disclosed herein are technically advantageous because they create an alternative way to transport UTVs and side-by-sides. Specifically, various configurations may be used to improve fuel efficiency, increase ease of transportation, and reduce risk of accidents and injuries. Other technical advantages will be apparent to those of ordinary skill in the art in view of the following specification, claims, and drawings.

One embodiment according to the present disclosure includes a trailer for the transportation of vehicles that includes a trailer frame, which includes: a rectangular base having a length and a width; and a plurality of slats disposed across the width and spaced along the length; wherein the plurality of slats is divided into a front portion group disposed horizontally relative to the trailer frame and a rear portion group disposed vertically relative to the trailer frame such that the front portion is recessed in height relative to the rear portion; a pair of storage ramps, which include: a first ramp; a second ramp; and one or more cross braces fastened between and the first ramp and the second ramp; wherein the pair of storage ramps has a thickness that is the same as the recessed height of the front portion; and a connector disposed between the front portion and one of the one or more cross braces, wherein the pair of storage ramps is pivotably connected to the trailer frame such that the pair of storage ramps covers the front portion when disposed in lowered position. The trailer may also include a plurality of lift supports disposed between the first portion and pair of storage ramps. In some embodiments, the trailer may include: a plurality of tie down rings disposed on the pair of storage ramps; a plurality of tie down rings disposed on the trailer frame; and a set of wheels disposed below the trailer frame configured to support said trailer frame. The trailer may also include: a trailer tongue attached to the first portion; a trailer hitch disposed on the trailer tongue; and a trailer hitch jack disposed on the trailer tongue. The trailer may also include a bed cover disposed on the first portion and the second portion.

Another embodiment according to the present disclosure includes a method of loading a trailer, including the steps of: moving a first vehicle onto a rear portion of the trailer, the trailer including: a trailer frame that includes: a rectangular base having a length and a width; and a plurality of slats disposed across the width and spaced along the length; wherein the plurality of slats is divided into a front portion group disposed horizontally relative to the trailer frame and the rear portion group disposed vertically relative to the trailer frame such that the front portion is recessed in height relative to the rear portion; a pair of storage ramps, which include: a first ramp; a second ramp; and one or more cross braces fastened between and the first ramp and the second ramp; wherein the pair of storage ramps has a thickness that is the same as the recessed height of the front portion; and a connector disposed between the front portion and one of the one or more cross braces, wherein the pair of storage ramps is pivotably connected to the trailer frame such that the pair of storage ramps covers the front portion when disposed in lowered position; moving the first vehicle onto the pair of storage ramps on the front portion of the trailer; elevating the pair of storage ramps from a lowered position to a raised position; and moving a second vehicle onto rear portion of the trailer. The method may include where the moving of the second vehicle may include at least a portion of the second vehicle being disposed beneath at least a portion of the first vehicle. The method may also include a step of securing at least one of the first vehicle to the pair or ramps or the second vehicle to trailer frame.

Another embodiment according to the present disclosure includes a method of unloading a trailer with two vehicles loaded, including the steps of: moving a second vehicle off of a rear portion of the trailer, the trailer including: a trailer frame that includes: a rectangular base having a length and a width; and a plurality of slats disposed across the width and spaced along the length; wherein the plurality of slats is divided into a front portion group disposed horizontally relative to the trailer frame and the rear portion group disposed vertically relative to the trailer frame such that the front portion is recessed in height relative to the rear portion; a pair of storage ramps, which includes: a first ramp; a second ramp; and one or more cross braces fastened between and the first ramp and the second ramp; wherein the pair of storage ramps has a thickness that is the same as the recessed height of the front portion; and a connector disposed between the front portion and one of the one or more cross braces, wherein the pair of storage ramps is pivotably connected to the trailer frame such that the pair of storage ramps covers the front portion when disposed in lowered position; lowering the pair of storage ramps from the raised position to the lowered position; and moving the first vehicle from the front portion of the trailer off of the trailer. The moving of the second vehicle step may include positioning at least a portion of the second vehicle beneath at least a portion of the first vehicle when loaded. The method may also include a step of releasing securing fasteners holding at least one of: the first vehicle to the pair or ramps and the second vehicle to trailer frame.

### BRIEF DESCRIPTION OF THE DRAWINGS

A better understanding of the present disclosure can be obtained with the following detailed descriptions of the various disclosed embodiments in the drawings, which are given by way of illustration only, and thus are not limiting the present disclosure, and wherein:

FIG. 1A is a diagram of a trailer configured to hold multiple UTVs with a pair of storage ramps in the lowered position according to one embodiment of the present disclosure.

FIG. 1B is a diagram of the trailer of FIG. 1A with the pair of storage ramps in the fully elevated position.

FIG. 2 is a diagram of the trailer of FIG. 1A loaded with UTVs and attached for towing according to one embodiment of the disclosure.

FIG. 3A is a top view diagram of a trailer frame for the trailer of FIG. 1A.

FIG. 3B is side view diagram of the trailer frame for the trailer of FIG. 1A.

FIG. 4. is a flow chart for a method of loading vehicle onto the trailer of FIG. 1A.

FIG. 5 is a flow chart for a method of unloading vehicles from the trailer of FIG. 1A.

FIG. 6A is a diagram showing a first vehicle next to a trailer of FIG. 1A prior to loading.

FIG. 6B is a diagram showing a first vehicle on the rear portion of the trailer of FIG. 1A.

FIG. 6C is a diagram showing a first vehicle on the front portion of the trailer of FIG. 1A when the pair of ramps is in the lowered position.

FIG. 6D is a diagram showing the first vehicle on the pair of ramps of the trailer of FIG. 1A when the ramps are in the raised position.

FIG. 6E is a diagram showing a second vehicle on the rear portion of the trailer of FIG. 1A while the first vehicle is on the raised ramps.

### DETAILED DESCRIPTION OF THE DISCLOSURE

The trailer setup is designed to solve the problem of hauling various combinations of vehicles efficiently. For instance, this set up may be used to transport two four-wheel vehicles, such as two side-by-sides or two UTVs. Alternatively, this set up may be used to transport two motorcycles and a car or other four-wheel vehicle on the back. Traditionally, motorcycles can only be transported on a flat trailer. The present disclosure includes an embodiment that is configured for a UTVs or side-by-side to be driven onto a flat trailer, secured when the bed is flat, and the lift the UTV or side-by-side into an angled storage position so that a second UTV or side-by-side may be loaded onto the flat trailer. In another embodiment, the trailer may be configured for motorcycles to be driven onto a flat trailer, secured while the bed is flat, and then lift the motorcycles into an angled storage position to reduce the amount trailer length required to hold the motorcycles and make room for another vehicle to be loaded onto the flat portion of the trailer.

This feature provides great versatility, including allowing you to haul multiple types of vehicles with ease. This versatility can eliminate the need for several different types of trailers, simplifying logistics and saving time and money in the transportation of motorcycles, UTVs, cars, or a mix of vehicles.

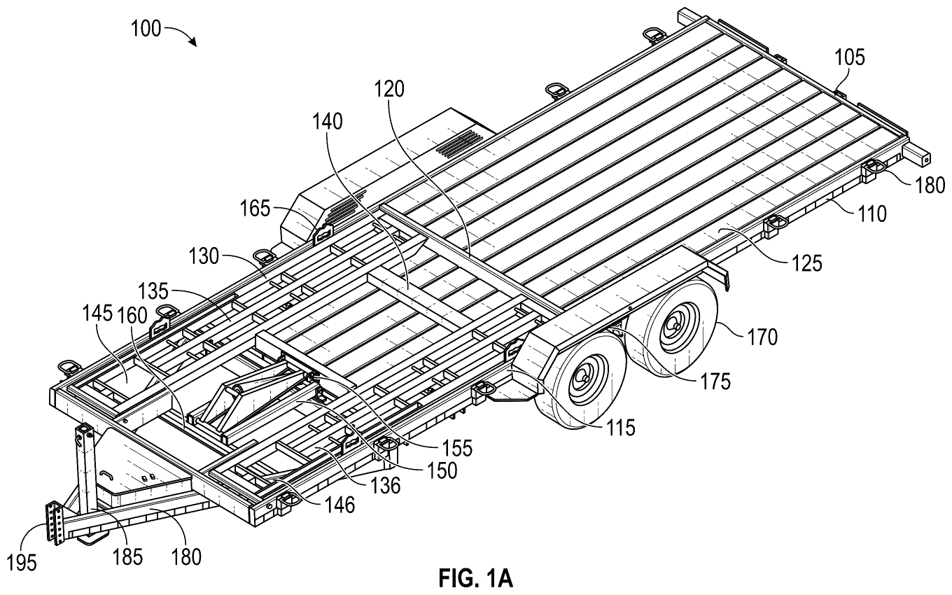

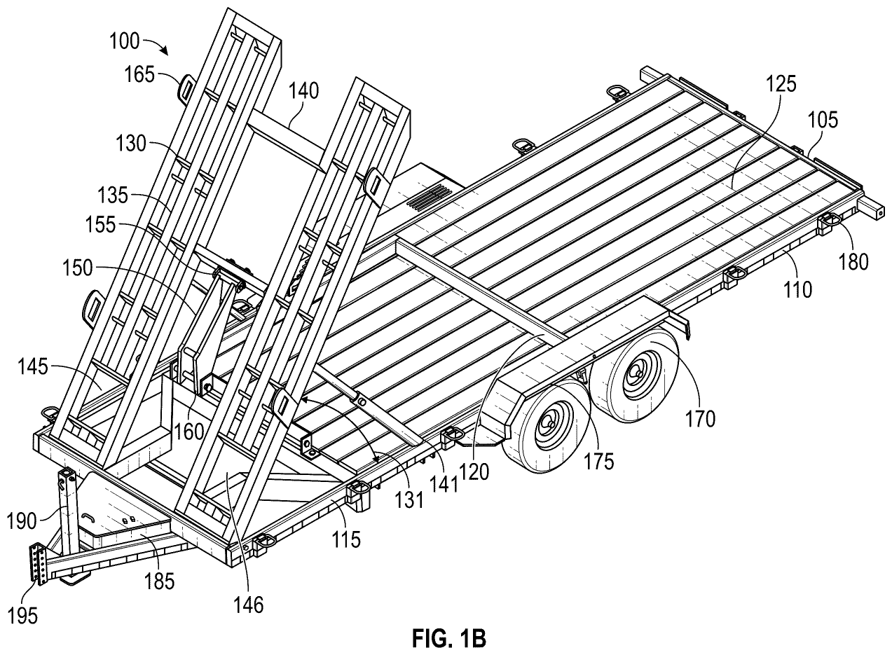

FIG. 1A shows one embodiment of a trailer 100 according to the present disclosure. The trailer 100 includes a frame 105 in the configuration of a utility trailer. The frame 105 includes a rear portion 110 and a front portion 115. The front portion 115 is recessed relative to the rear portion 110, and the two portions are divided by a step 120. The step 120 may be made of any suitable material, such as steel, including the same material as the frame 105. Both the front portion 115 and the rear portion 110 may include a bed liner 125. The bed liner 125 may be made of heavy duty plastic, wood, or fiber glass, such that the bed liner 125 is selected to support the weight of the load placed in the trailer 100 without damage. The front portion 115 is recessed sufficiently to accept a pair of storage ramps 130 such that the pair of storage ramps 130 and the rear portion 110 are flush when the storage ramp 130 is in a fully lowered position. In some embodiments, the fully lowered position is when the pair of storage ramps 130 is resting on the top of the first portion 115 of the frame 105. The pair of storage ramps 130 may include a first ramp 135 and a second ramp 136 that are connected by one or more cross braces 140. Ideally, the first ramp 135 and the second ramp 136 have the same thickness. The ramps 135, 136 have the same length, which may be between about 38 inches (0.97 m) and about 78 inches (2.1 m).

The first ramp 135 and the second ramp 136 are shown as configured and spaced apart by the one or more cross braces 140 to such that they may be held in position to receive a four-wheel vehicle. In some embodiments, the first ramp 135 and the second ramp 136 may be made of aluminum tube, such as 6061-T6 or a suitable alternative as would be understood by a person of ordinary skill in the art. Using aluminum tube in the first ramp 135 and the second ramp 136 can reduce the weight of the trailer 100, though other materials with suitable strength and weight may be used as alternatives. In some embodiments, the ramps 135, 136 may have a top layer of tread plate, especially, if the aluminum tubes are spaced such that it may leave gaps that will render it difficult to load or unload a vehicle safely.

Each individual ramp 135, 136 may, optionally, be configured to receive a two-wheel vehicle, such as a motorcycle. Each ramp section 135, 136 may include an optional opening 145, 146 configured to receive a wheel from a vehicle mounted on the respective ramp 135, 136. The optional opening 145, 146 may make a mounted vehicle more secure during transport and prevent a vehicle from being driven off the front of the ramp. 135, 136. The optional opening 145, 146 may be dimensioned with a width of about 13.5 inches (about 0.34 meters) and a length of about 15 inches (about 0.38 meters). While the dimensions may vary, they are substantially sized to accommodate the widest tires of a UTV or side-by-side, and sufficient to receive the length of wheel without allowing the chassis or frame of the UTV or side-by-side to contact the ramps 135, 136. The pair of storage ramps 130 may be pivotably connected to one of the cross braces 140 by a pivot element 150. The pivot element 150 is connected to one of the one or more cross braces 140 on a first side 155 of the pivot element 150 and connected to the frame 105 with a pivotable connection on a second side 160 of the pivot element 150. In some embodiments, the pivot element 150 may include a scissor hoist. Each of the ramps 135, 136 may be attached to a lift support 141 (shown in FIG. 1B) between each of the ramps 135, 136 and the frame 105. The lift support 141 acts as a lock bar to support the ramps 135, 136. In some embodiments, each of the lift supports 141 may include a tube with one or more holes for a pin to be inserted when the ramps 135, 136 are at one or more angles 131 (see FIG. 1B). In some embodiments, the tube portion may be made of A500 Grade B structural steel or its substantial equivalent. The tube may have an outer diameter of 2 inches (5.1 cm) and an inner diameter of 1.5 inches (3.8 cm).

The ramps 135, 136 may include tie down rings 165 configured to allow a vehicle to be secured. The tie down rings 165 may be disposed along the ramps 135, 136 to the proximate to the outside of the frame 105. The trailer 100 also includes wheels 170 and a wheel well covers 175 on each side. The frame 105 may include tie down rings 180 as well. The tie down rings 180 may be disposed along the outside perimeter of the frame. 105. The frame 105 includes a nose or trailer tongue section 185 attached to the front portion 115. A hitch jack 190 and a hitch 195 may be attached to the trailer tongue 185 so that the trailer 100 is capable of receiving a hitch from a towing vehicle.

FIG. 1B shows a diagram of the trailer of FIG. 1A with the pair of storage ramps 130 in a fully elevated position. When fully elevated, the pair of storage ramps 130 and the frame 105 form an angle 131. The angle 131 is selected so that one or more vehicles secured to the pair of storage ramps 130 may be elevated such that another vehicle may secured at least partially beneath the one or more vehicles residing on the pair of ramps 130. In some embodiments, the pair of storage ramps 130 may be structured so that the angle 131 ranges from 0 degrees to 50 degrees. There may be intermediate locking positions within that range. In some embodiments, the angle 131 may be set to about 26 degrees, about 31 degrees, about 36 degrees, about 40 degrees, about 45 degrees, and about 50 degrees in addition to the lowered position at 0 degrees. These positions are illustrative and exemplary, as any number of positions within the range of 0 degrees to 50 degrees may be used as would be understood by a person of ordinary skill in the art.

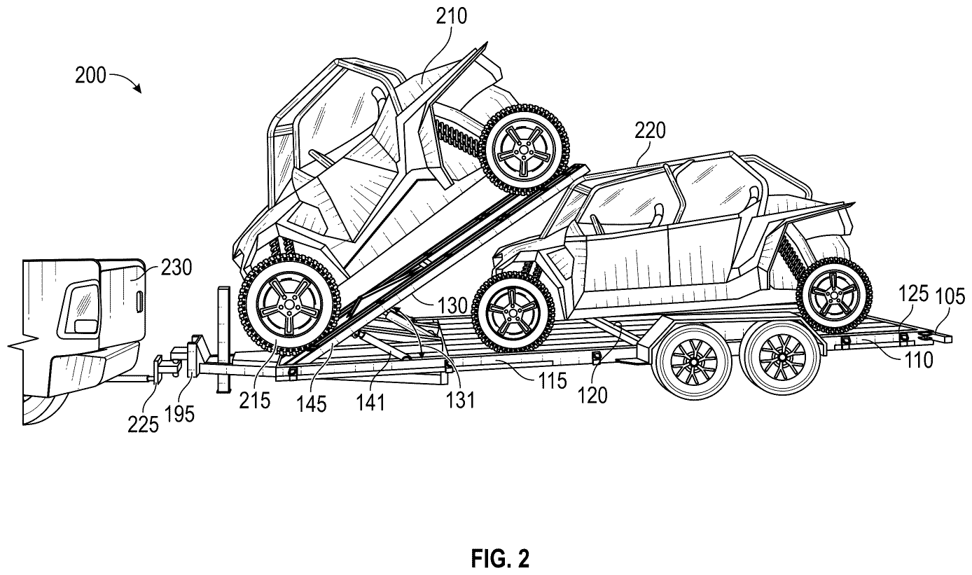

FIG. 2 shows a diagram of the trailer of FIG. 1B with a first vehicle 210 loaded onto the pair of storage ramps 130 and a second vehicle 220 stored behind and partially beneath the first vehicle 210. The first vehicle 210 may be positioned such that at least one of its wheels 215 is at least partially inserted in at least one of the ramp openings 145, 146 to prevent movement of the first vehicle 210 while on the ramp 135, 136 or pair of storage ramps 130. The figure also shows a towing vehicle 230 connected to the hitch 195 by its own tow hitch 225.

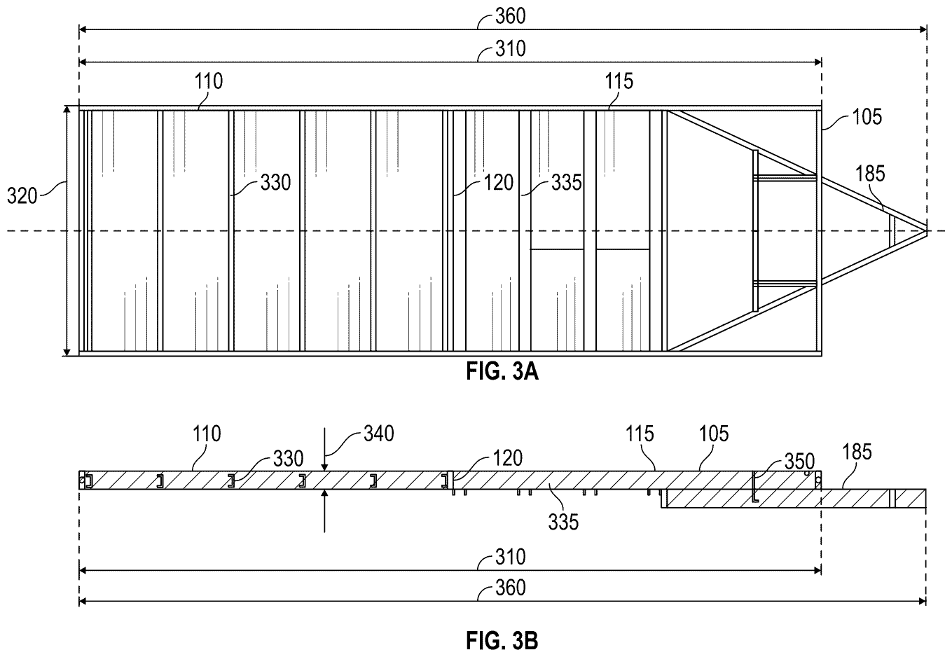

FIGS. 3A and 3B show a diagram of the trailer frame 105 according to one embodiment of the present disclosure. FIG. 3A shows a top view of the trailer frame 105. The trailer frame 105 has a length 310 and a width 320 of the base of the frame 105 that is designed to hold vehicles. In some embodiments, the length 310 may be 20 feet (6.1 meters). In some embodiments, the width 320 may be about 82 inches (2.1 m). The frame 105 includes longitudinal and lateral pieces that form the perimeter of the frame 105 and hold slats 330, 335 between them to form the generally rectangular base. The rear portion 110 includes slats 330, and the front portion 115 includes slats 335. The step 120 acts as the division between the rear portion 110 and the front portion 115. The longitudinal and lateral pieces may be any suitable tube or channel material that is sufficiently strong to support the weight of the load and comply with design safety requirements as would be understood by a person of ordinary skill in the art. In one embodiment, the longitudinal and lateral pieces may be made of tube or C-channel steel and suitable for the trailer to support a 500 kg load.

FIG. 3B shows a side view of the trailer frame 105 so that it can be seen that the frame 105 has a height 340 that corresponds to thickness of the pair of storage ramps 130. The slats 330, 335 are arranged between longitudinal members of the frame 105. The slats 330 are disposed in the rear portion 110 and oriented to have a height greater than their width and have a height less than the height 340. The slats 335 are disposed in the front portion 115 and arranged to be wider than tall and to form a recessed bed that is configured to receive the pair of storage ramps 130. The recessed bed has a depth approximately the same as the height 340. In this way, when the pair of storage ramps 130 are fully recessed into the frame 105, the trailer 100 has a flat surface for a vehicle to move between the rear portion 110 and the front portion 115. The trailer tongue 185 is attached to the front portion 115 at multiple points where the trailer tongue 185 intersects points of the front portion 115 (FIG. 3A). A pair of longitudinal elements 350 are provided as attachment points for ramp pins (one per ramp) that secure one end of the ramp 135, 136 to the frame 105 and allow the respective ramps 135, 136 to rotate (pivot) around the ramp pins to form and adjust the angle 131. The overall length 360 of the frame 105 is greater than the usable length 310 for vehicles by the distance that the tongue 185 extends to attach the hitch 195 and provide distance between the trailer 100 and the towing vehicle 230.

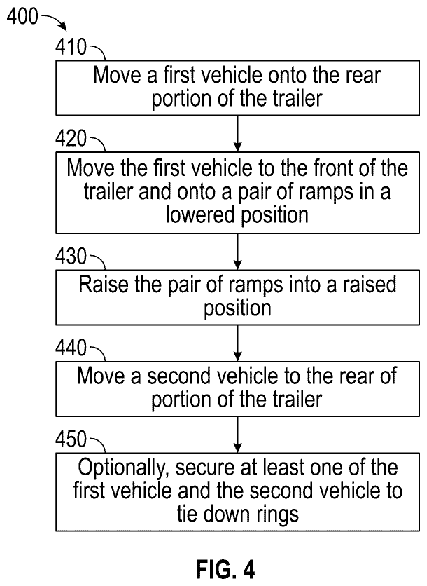

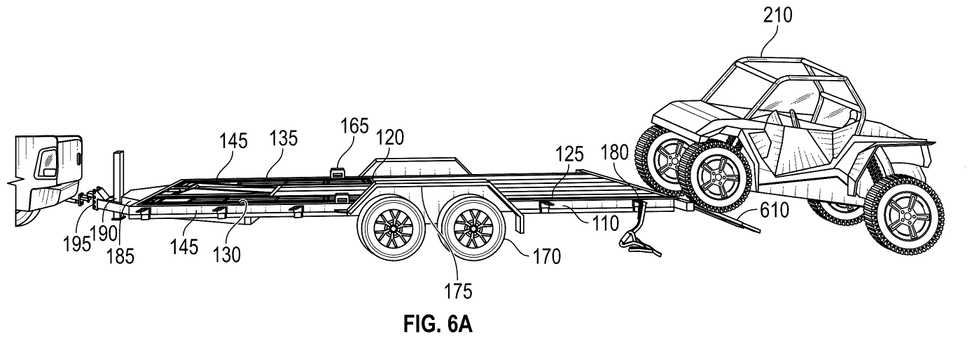

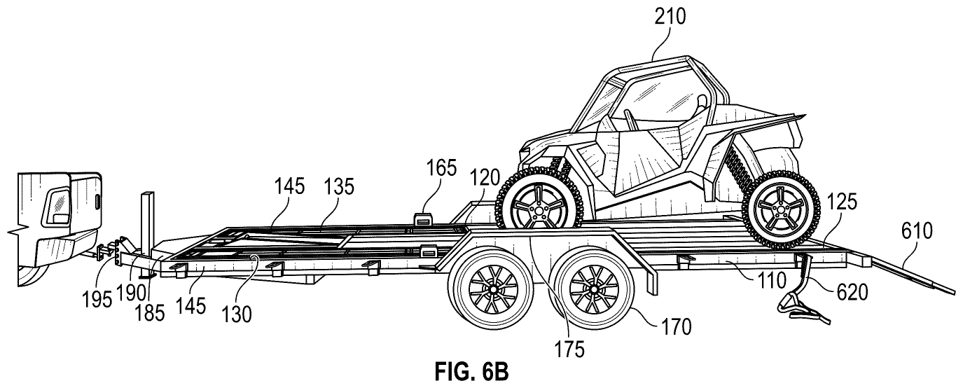

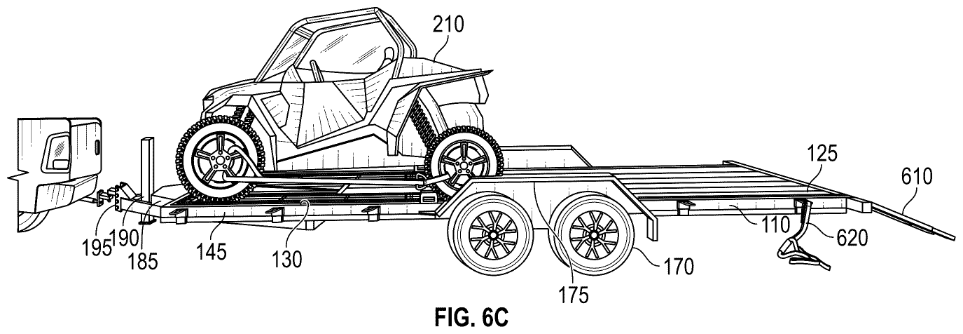

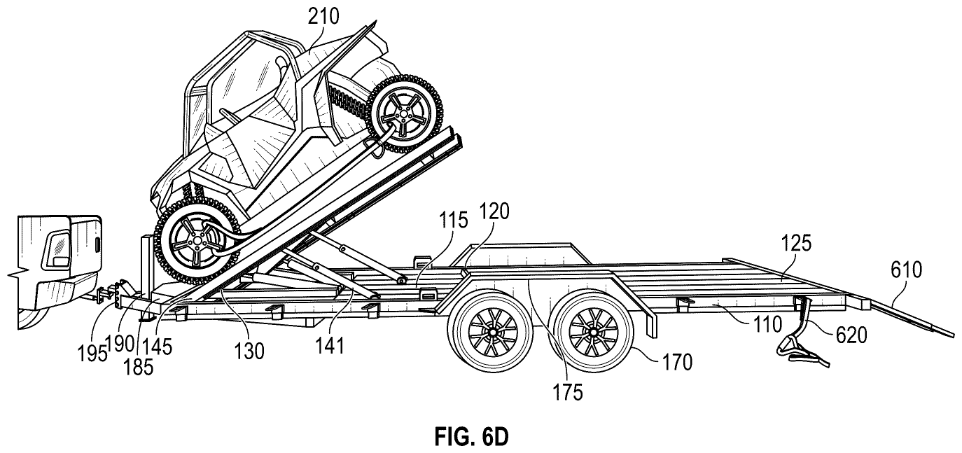

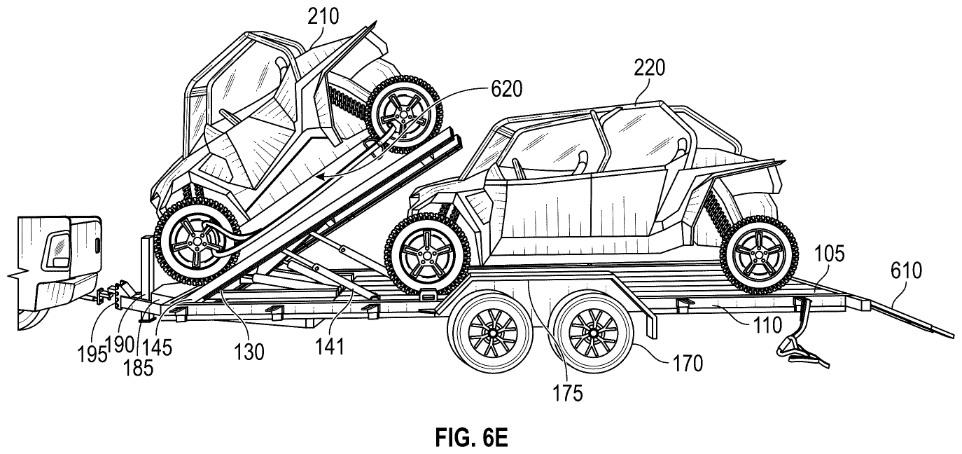

FIG. 4 shows a flow chart for a method 400 for loading vehicles onto the trailer 100. Images of the arrangement of the vehicles relative to the trailer 100 are shown in FIGS. 6A-6E. In operation, the trailer may be loaded using method 400. FIG. 6A shows the first vehicle 210 sitting next to the trailer 100 and ready for loading. The trailer 100 is shown with ramp 610 for the first vehicle to be moved up onto the rear portion 110. In step 410, the first vehicle 210 is moved to onto the rear portion 110 of the trailer 100 while the pair of storage ramps 130 is in the lowered position. See FIG. 6B. In step, 420, the first vehicle 210 is moved to the front portion 115 onto the pair of storage ramps 130. See FIG. 6C. In step 430, the pair of storage ramps 130 is raised into the elevated position. See FIG. 6D. In step 440, the second vehicle 220 is moved onto the rear portion 110. See FIG. 6E. In step 450, one or more of the vehicles are optionally secured to either the rear portion 110 or the pair of storage ramps 130 using the tie down rings 165, 180. Straps 620 may be used for securing the vehicles to the tie down rings 165, 180. Typically, the first vehicle 210 is a four-wheel vehicle; however, in some embodiments, the first vehicle 210 may be one or two two-wheeled vehicles, such as one or two motorcycle(s), which is/are loaded onto at least one of the storage ramps 135, 136.

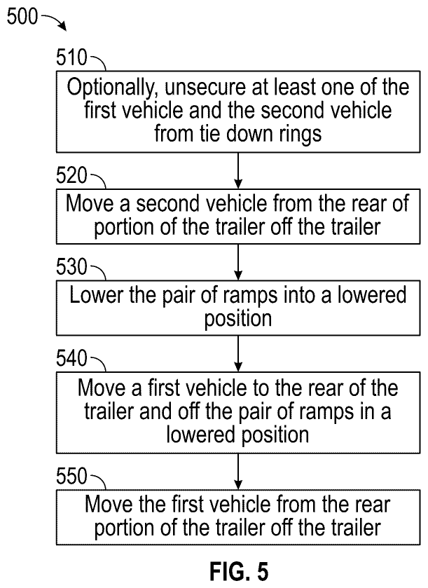

FIG. 5 shows a flow chart for a method 500 for unloading vehicles from the trailer 100 Images of the arrangement of the vehicles relative to the trailer 100 are shown in FIGS. 6A-6E. In operation, the trailer may be unloaded using method 500, which generally reverses the method 400. FIG. 6E shows the trailer 100 with two vehicles 210, 220 on it. In step 510, one or more of the vehicles 210, 220, if secured to either of the tie down rings 165, 180, may be unsecured. In some embodiments, individual vehicles may remain secured until it is their time to be moved. In step 520, the second vehicle 220 is moved off of the rear portion 110. See FIG. 6D. In step 530, the pair of storage ramps 130 is lowered into the lowered position, where the storage ramps 130 are in the recessed area. See FIG. 6C. In step, 540, the first vehicle 210 is moved to the rear portion 115 from the pair of storage ramps 130. See FIG. 6B. In step 550, the first vehicle 210 is moved to off of the rear portion 110 of the trailer 100 to the ground. See FIG. 6A. As with the method 400, in the method 500, in some embodiments, the first vehicle 210 may be one or two two-wheeled vehicle, such as one or two motorcycle(s), which is/are stored on at least one of the storage ramps 135, 136.

The foregoing disclosure and description of the disclosure are illustrative and explanatory thereof, and various changes in the details of the illustrated device and system, and the construction and the method of operation may be made without departing from the spirit of the disclosure.

What is claimed is:

1. A trailer for the transportation of vehicles, comprising:
a trailer frame comprising:
a rectangular base having a length and a width; and
a plurality of slats disposed across the width and spaced along the length;
wherein the plurality of slats is divided into a front portion group disposed horizontally relative to the trailer frame and a rear portion group disposed vertically relative to the trailer frame such that the front portion is recessed in height relative to the rear portion;
a pair of storage ramps comprising:
a first ramp;
a second ramp; and
one or more cross braces fastened between and the first ramp and the second ramp;
wherein the pair of storage ramps has a thickness that is the same as the recessed height of the front portion; and
a connector disposed between the front portion and one of the one or more cross braces, wherein the pair of storage ramps is pivotably connected to the trailer frame such that the pair of storage ramps covers the front portion when disposed in lowered position.

2. The trailer of claim 1 further comprising:
a plurality of lift supports disposed between the first portion and pair of storage ramps.

3. The trailer of claim 1 further comprising:
a plurality of tie down rings disposed on the pair of storage ramps;
a plurality of tie down rings disposed on the trailer frame; and
a set of wheels disposed below the trailer frame configured to support said trailer frame.

4. The trailer of claim 1 further comprising:
a trailer tongue attached to the first portion;
a trailer hitch disposed on the trailer tongue; and
a trailer hitch jack disposed on the trailer tongue.

5. The trailer of claim 1 further comprising:
a bed cover disposed on the first portion and the second portion.

6. A method of loading a trailer, comprising the steps of:
moving a first vehicle onto a rear portion of the trailer, the trailer comprising:
a trailer frame comprising:
a rectangular base having a length and a width; and
a plurality of slats disposed across the width and spaced along the length;
wherein the plurality of slats is divided into a front portion group disposed horizontally relative to the trailer frame and the rear portion group disposed vertically relative to the trailer frame such that the front portion is recessed in height relative to the rear portion;
a pair of storage ramps comprising:
a first ramp;
a second ramp; and
one or more cross braces fastened between and the first ramp and the second ramp;
wherein the pair of storage ramps has a thickness that is the same as the recessed height of the front portion; and
a connector disposed between the front portion and one of the one or more cross braces, wherein the pair of storage ramps is pivotably connected to the trailer frame such that the pair of storage ramps covers the front portion when disposed in lowered position;
moving the first vehicle onto the pair of storage ramps on the front portion of the trailer;
elevating the pair of storage ramps from a lowered position to a raised position; and
moving a second vehicle onto rear portion of the trailer.

7. The method of claim 6, wherein
at least a portion of the second vehicle is disposed beneath at least a portion of the first vehicle.

8. The method of claim 6, further comprising the step of:
securing at least one of the first vehicle to the pair or ramps or the second vehicle to trailer frame.

9. A method of unloading a trailer with two vehicles loaded, comprising the steps of:
moving a second vehicle off of a rear portion of the trailer, the trailer comprising:
a trailer frame comprising:
a rectangular base having a length and a width; and
a plurality of slats disposed across the width and spaced along the length;
wherein the plurality of slats is divided into a front portion group disposed horizontally relative to the trailer frame and the rear portion group disposed vertically relative to the trailer frame such that the front portion is recessed in height relative to the rear portion;
a pair of storage ramps comprising:
a first ramp; and
a second ramp;
one or more cross braces fastened between and the first ramp and the second ramp;
wherein the pair of storage ramps has a thickness that is the same as the recessed height of the front portion; and
a connector disposed between the front portion and one of the one or more cross braces, wherein the pair of storage ramps is pivotably connected to the trailer frame such that the pair of storage ramps covers the front portion when disposed in lowered position;
lowering the pair of storage ramps from the raised position to the lowered position; and
moving the first vehicle from the front portion of the trailer off of the trailer.

10. The method of claim 9, wherein at least a portion of the second vehicle is disposed beneath at least a portion of the first vehicle when loaded.

11. The method of claim 9, further comprising the step of:
releasing securing fasteners holding at least one of: the first vehicle to the pair or ramps and the second vehicle to trailer frame.
